(19) United States
(12) Patent Application Publication
(10) Pub. No.: US 2014/0181261 A1
(43) Pub. Date: Jun. 26, 2014

(54) METHOD AND APPARATUS FOR PROVIDING EFFICIENT TRANSMISSION OF STREAMING VIDEO THROUGH A COMPLEX IP NETWORK

(71) Applicant: Alcatel-Lucent USA Inc., Murray Hill, NJ (US)

(72) Inventors: John SHAMILIAN, Tinton Falls, NJ (US); Tom L. WOOD, Colts Neck, NJ (US)

(73) Assignee: Alcatel-Lucent USA Inc., Murray Hill, NJ (US)

(21) Appl. No.: 13/726,812

(22) Filed: Dec. 26, 2012

(51) Int. Cl. H04L 29/06

(52) U.S. Cl. CPC H04L 65/60
USPC 709/219

(57) ABSTRACT

A method of streaming media on an IP network includes receiving, at a media server, a request for a first media item from a first remote client in a first remote subnet of the IP network; determining a total number of clients of the first remote subnet that are requesting the first media item from the media server; generating a comparison result based on the determined number and a threshold value; and if the generated comparison result indicates that the determined number is greater than the threshold value, sending a signal from the media server to initiate a first relay server in the first subnet, and sending a signal from the media server instructing the first remote client to obtain the first media item from the first relay server.

### BACKGROUND

1. Field

Example embodiments relate generally to streaming data, including for example video data, through a communications network.

2. Related Art

Some networks are created with a complex interconnection of local area network (LAN) campuses and wide area network (WAN) connections of those campuses. Example include this also applies to internet service provider (ISP) networks which are created in clusters. Streaming video of live events, for example events which are viewed in concert, may require video data to be provided from a server associated with the live content to many users over a WAN connection.

### SUMMARY

According to at least one example embodiment, a method of streaming media on an IP network may include receiving, at a media server, a request for a first media item from a first remote client in a first remote subnet of the IP network; determining a total number of clients of the first remote subnet that are requesting the first media item from the media server; generating a comparison result based on the determined number and a threshold value; and if the generated comparison result indicates that the determined number is greater than the threshold value, sending a signal from the media server to initiate a first relay server in the first subnet, and sending a signal from the media server instructing the first remote client to obtain the first media item from the first relay server.

According to at least one example embodiment, a media server for facilitating the streaming of media on an IP network may include a processing unit configured to control operations associated with streaming media, the operations including, receiving, at the media server, a request for a first media item from a first remote client in a first remote subnet of the IP network; determining a total number of clients of the first remote subnet that are requesting the first media item from the media server; generating a comparison result based on the determined number and a threshold value; and if the generated comparison result indicates that the determined number is greater than the threshold value, sending a signal from the media server to initiate a first relay server in the first subnet, and sending a signal from the media server instructing the first remote client to obtain the first media item from the first relay server.

According to at least one example embodiment, the method may further include, if the generated comparison result indicates that the determined number is greater than the threshold value, determining if any other clients in the first subnet are receiving the first media item from the media server, and instructing the other clients in the first subnet determined to be receiving the first media item from the media server to obtain the media item from the first relay server.

According to at least one example embodiment, the method may further include, if the generated comparison result indicates that the determined number is greater than the threshold value, determining if an intervening relay server exists, the intervening relay server being a relay server that is closer to the first client than the media server is; if the intervening relay server is determined to exist, streaming the first media item from the media server to the intervening server, and sending a signal from the media server instructing the first relay server to obtain the first media item from the intervening relay server; and if no intervening relay server is determined to exist, streaming the first media item from the media server to the first relay server.

According to at least one example embodiment, the method may further include, if the generated comparison result indicates that the determined number is not greater than the threshold value, streaming the first item from the media server to the first client.

According to at least one example embodiment, the media server and the first remote client are in different subnets, and the media server communicates with the first subnet via a wide access network (WAN) link.

According to at least one example embodiment, the first media item includes video data.

### BRIEF DESCRIPTION OF THE DRAWINGS

At least one example embodiment will become more fully understood from the detailed description provided below and the accompanying drawings, wherein like elements are represented by like reference numerals, which are given by way of illustration only and thus are not limiting of example embodiments and wherein:

FIG. 1A illustrates a communication network.

FIG. 1B illustrates an example of the communication network with additional clients.

FIG. 2 illustrates a communication network in accordance with at least one example embodiment.

FIG. 3A is a diagram illustrating an example structure of a network element in accordance with at least one example embodiment.

FIG. 3B is a flow chart illustrating a method for providing streaming video to multiple clients efficiently over a WAN link in accordance with at least one example embodiment.

FIGS. 4A-4C illustrate an example operation of a communications network where multiple remote clients are receiving requested video data in accordance with at least one example embodiment.

FIG. 5 illustrates an example operation of a communications network where multiple subnets are receiving requested video data in accordance with at least one example embodiment.

### DETAILED DESCRIPTION OF EXAMPLE EMBODIMENTS

Various at least one example embodiment will now be described more fully with reference to the accompanying drawings in which some example embodiments are shown.

Detailed illustrative embodiments are disclosed herein. However, specific structural and functional details disclosed herein are merely representative for purposes of describing at least one example embodiment. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits (ASICs), field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

### Example of Video Streaming

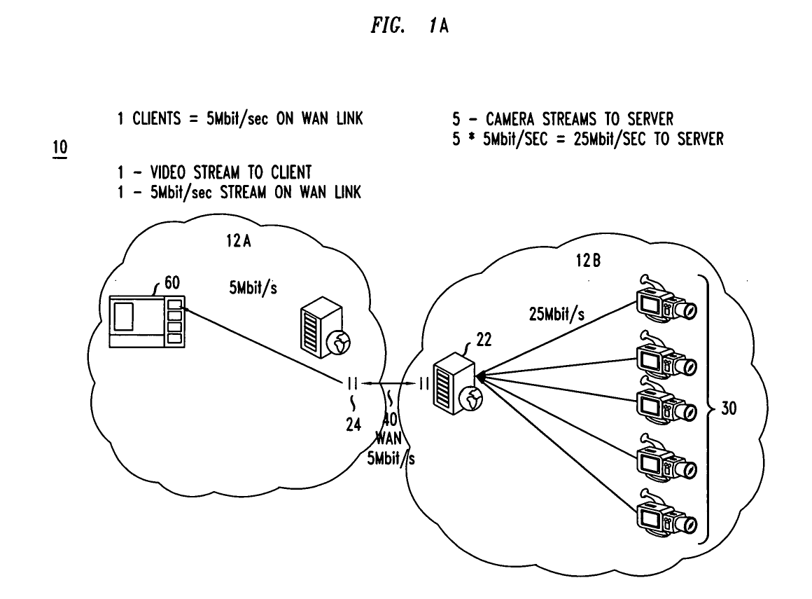

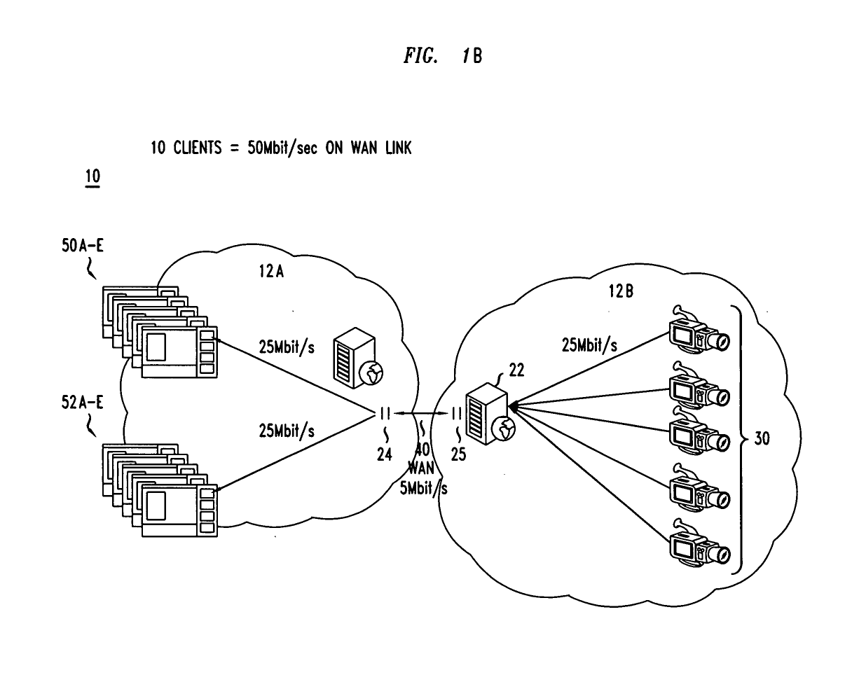

FIG. 1A illustrates a communication network 10. Communications network 10 may be, for example, an internet protocol (IP) network. Communications network 10 includes two local area networks (LANs) LAN 12A and LAN 12B. LAN 12B includes a video server 22 and a wide area network (WAN) link device 25 for communicating with non-local devices or networks over the WAN link 40. The video server 22 receives video data from multiple video sources 30. Though the term video data is used for simplicity, all processes discussed herein with respect to video data may also be performed with respect to audio data or a combination of video and audio data.

Video sources 30 may be, for example, cameras located at different locations capturing a live event. Video server 22 receives the video data generated by video sources 30, and stores the received video data. Video server 22 may implement the real time streaming protocol (RTSP). For example, the Video server 22 may offer the stored video content to local clients on the LAN 12B as well as clients on the LAN 12A.

The LAN 12A includes a WAN link device 24 for communicating with non-local devices and networks over the WAN link 40. The LAN 12A includes client 60. In the example illustrated in FIG. 1A, the client 60 is receiving a stream of video data from the Video server 22 via the WAN link 40. Using known techniques, the client 60 may control the video stream, for example, by using stream control functions provided by the RTSP protocol including, for example, functions for performing play, pause, fast forward, rewind and stop operations.

In the example illustrated in FIG. 1A, there are five video sources 30. The fiver video sources each produce 5 megabits per second (Mbps) streams. The client 60 is viewing a single stream from one of the five video sources. Accordingly, the bandwidth of the data which needs to pass over the WAN link 40 in order to serve the client 60 is 5 Mbps. As used herein, the term bandwidth refers to a rate of data, or an amount of data (e.g., megabytes (MBs), megabits (Mbs), bits, etc) being sent per unit time (e.g., minutes, seconds, etc).

FIG. 1B illustrates an example of the communication network 10 with additional clients. In FIG. 1B, ten clients, clients 50A-E and clients 51A-E, each receive one of the 5 Mbps streams generated by one the video source 30 from the Video server 22. Accordingly, in FIG. 1B, instead of one client in the the LAN 12A receiving a stream of video content from the Video server 22 over the WAN link 40, there are ten. Consequently, the total bandwidth of data required to serve clients 50A-E and 51A-E is 5 Mbps×10 clients=50 Mbps.

In general, WAN link devices, including for example network bridges and routers, are expensive to operate. Further, the expense of deploying and operating a WAN link may increase with the maximum bandwidth the WAN link needs to handle. Further, the transmission of large amounts of video data over a WAN link can cause congestion which may result in other data being sent over the WAN link being delayed or lost. Accordingly, it would be desirable to develop a method of providing large amounts of video data, including for example live streaming video data, over a WAN link to multiple clients efficiently in a manner which reduces the amount of WAN link bandwidth which must be used to transfer the video data. A method for streaming video data over a WAN link efficiently will now be discussed in greater detail below.

### Network Architecture for Providing Video Streams to Multiple Clients Efficiently Over a WAN Link

As is discussed above, as a number of clients requesting a stream of video data over a WAN link increases, so does the bandwidth required on the WAN link to server the clients. Some proposed methods attempt to solve the problem of increased WAN link bandwidth requirements with the use of multicast networking. However, multicast networking is often used only with a single subnet. Further, there are many reasons for the limiting of multicast use. For example, multicast transmissions may be difficult to control, and the protocol for joining and releasing may be problematic from some clients. Further, multicast networking may require all the networking equipment and clients to run specific software in a consistent manner and to have been configured consistently.

According to example embodiments, a stream of video data may be provided from a digital video recorder (DVR) server to multiple clients over a WAN link efficiently with the use of a relay server. Accordingly, the video data may be streamed to multiple clients over a WAN link without using IP multicast techniques like, for example, Internet Group Management Protocol (IGMP).

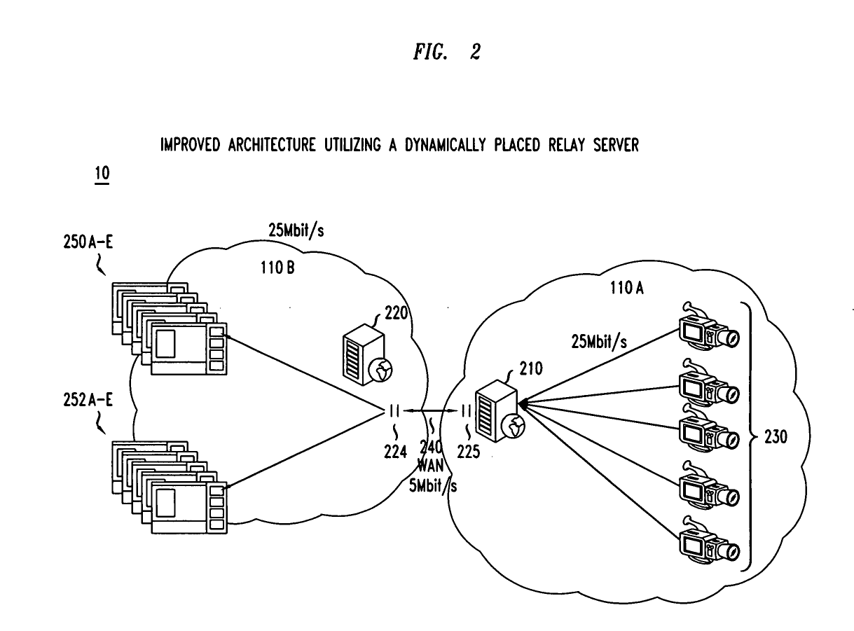

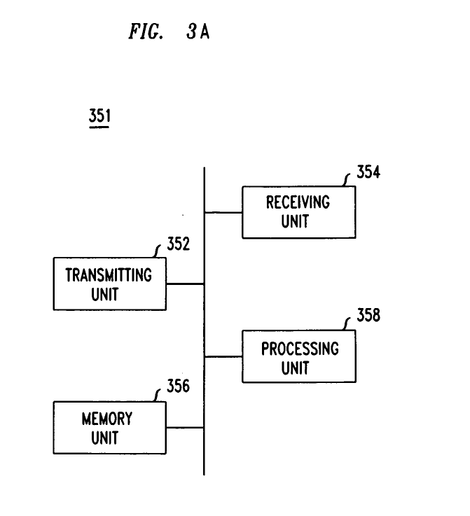

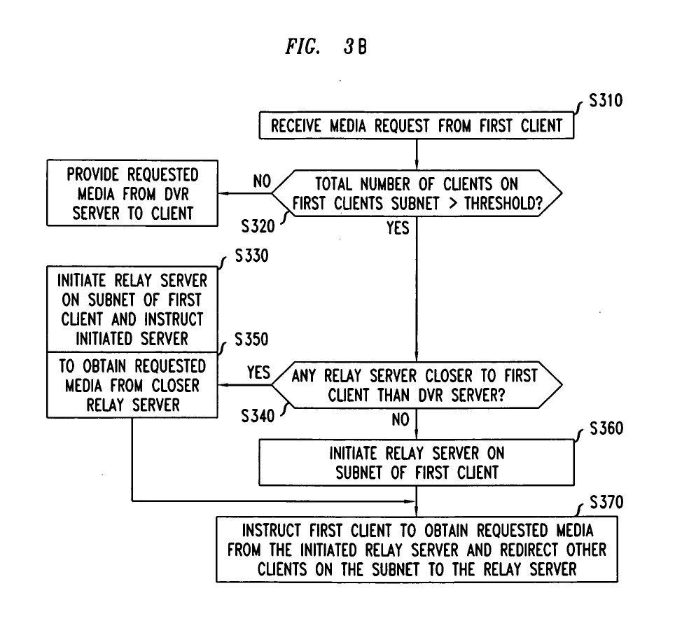

According to at least one example embodiment, the excessive bandwidth problem associated with transmission of video streams, for example for large live events, to multiple clients over a WAN link is addressed at the IP layer. By focusing on the IP layer, there is less need to focus on the requirements of the underlying layers. For example, according to at least one example embodiment, the method for streaming video data to multiple clients over a WAN link efficiently may be implemented using the RTSP protocol. According to at least one example embodiment, the Real-time Transport Protocol (RTP) layer is used for transmission of the video data. By creating a stream from the camera device, the stream can be captured and stored in a memory device, for example memory included in a DVR server. The stream can then be played from the memory device even as it is being stored, for example, with about one frame of delay approximately equal 1/30 second. In addition to the DVR server, a relay server is deployed. The relay server may be associated with a LAN which receives video data from the DVR server over a WAN link. The DVR server may be capable of handling RTSP requests from clients. The relay server may receive a single stream from the DVR server and send copies of the stream to multiple clients, or even other relay servers, using, for example, a in memory function, without the need for long term storage such as disk or flash memory. For example, data packets may be received into ram memory of the relay server and immediately transmitted out to clients without the need to store the data packets for later retrieval. By using the DVR server in conjunction with one or more relay servers, the number of streams which traverse any part of the communications network can be controlled. An example structure of a network implementing the method of streaming video data to multiple clients over a WAN link efficiently will now be discussed in greater detail below with reference to FIGS. 2, 3A and 3B.

FIG. 2 illustrates a communication network 100 in accordance with at least one example embodiment. Communications network 100 is an IP network that includes a first LAN 110A and a second LAN 110B which communicate with one another via a WAN link 240. The first LAN 110A includes a DVR server 210, a first WAN link device 225, and five video sources 230. The first WAN link 225 is a network device, including for example a network bridge or router, which provides the first LAN 110A with a connection to the WAN link 240. All data sent to or from the first LAN 110A via the WAN link 240 may be received by or sent from the first WAN link device 225. Similar to the example explained above with reference to FIGS. 1A and 1B, the video sources may be, for example, video cameras capturing a live event and producing video streams of the captured video data; and the DVR server 210 may receive and store video streams from video sources 230. Similar to FIGS. 1A and 1B, in the example illustrated in FIG. 2, each of the five video sources 230 generates a video stream having a bandwidth of 5 Mbps. The DVR server 210 may perform the same operations discussed above with reference to the video server 22 illustrated in FIGS. 1A and 1B. In addition, as will be discussed in greater detail below, the DVR server 210 is capable of working with a first relay server 220 to reduce the amount of bandwidth required from the WAN link 240 to stream video data

The second LAN 110B includes the first relay server 220 and a second WAN link device 224. The second WAN link device 224 is a network device, including for example a network bridge or router, which provides the second LAN 110B with a connection to the WAN link 240. All data sent to or from the second LAN 110B via the WAN link 240 may be received by or sent from the second WAN link device 224. In the example illustrated in FIG. 2, there are 10 clients, 250A-E and 252A-E, which are all viewing the same 5 Mbit stream of data from one of the video sources 230. However, in accordance with at least one example embodiment, instead of sending 10 individual streams of data totaling 50 Mbps from the DVR server 210 to the clients 250A-E and 252A-E, the DVR server only sends one 5Mbps stream across the WAN link 240 to the first relay server 220, not 50Mbps worth of video data. The first relay server 220 then sends copies of the 5Mbps stream to each of the clients 250A-E and 252A-E. Accordingly, the heavy data traffic is shifted from the WAN link 240 to the second LAN 110B.

In general, it is much less costly to implement and operate a LAN which can handle large amounts of data quickly than it is to do the same with a WAN. Thus, using the method of streaming video data to multiple clients over a WAN link efficiently, an operator of the wireless communication network 100 may provide video data to multiple users across a WAN link efficiently while reducing the need to incorporate costly WAN devices to increase the maximum bandwidth of the WAN link, and reducing the chances of slowing down other WAN traffic by creating excessive video streaming traffic on the WAN link.

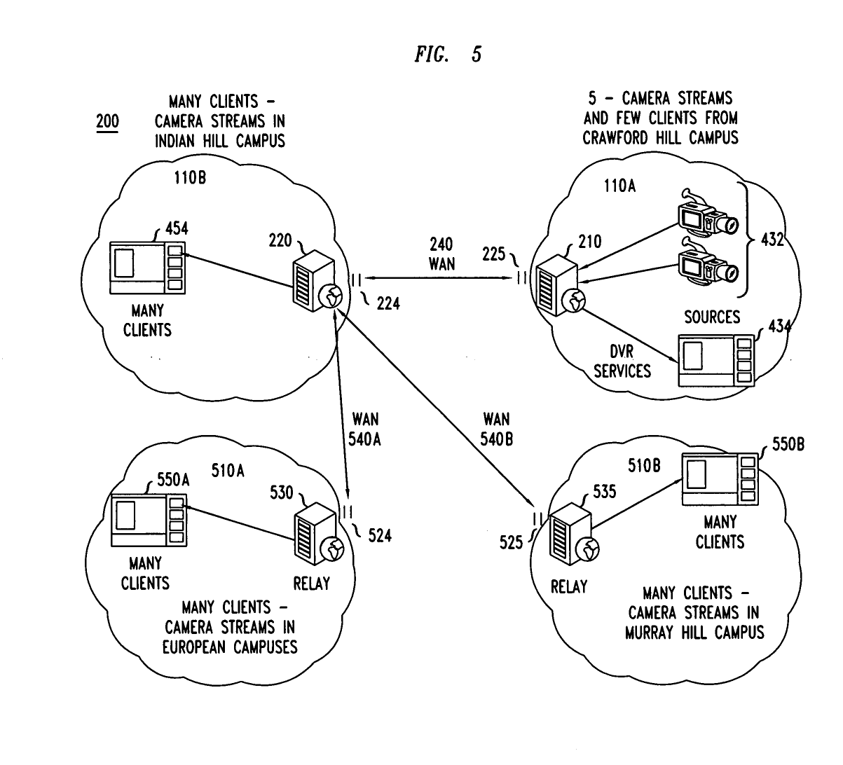

Further, though only one first relay server 220 is illustrated in FIG. 2, communications network 100 may include multiple relay servers each associated with a different LAN. According to at least one example embodiment, in order to reduce WAN link bandwidth requirements and to prevent latency issues, a relay server requesting video data is capable of receiving streaming video data not only from the DVR server, but also from other relay servers which may be closer in the IP network topology to the requesting relay server than the DVR server. The use of multiple relay servers will be discussed in greater detail below with reference to FIG. 3B and FIG. 5.

Apparatuses and methods for providing video data to multiple users across a WAN link will now be discussed in greater detail with reference to FIGS. 3A and 3B.

### Example Apparatus and Methods for Providing Streaming Video to Multiple Clients Efficiently Over a WAN Link

FIG. 3A is a diagram illustrating an example structure of a network element 351. The structure of the network element 351 described below may be included in in either or both of the DVR server 210 and the first relay server 220. Referring to FIG. 3A, the network element 351 may include, for example, a data bus 359, a transmitting unit 352, a receiving unit 354, a memory unit 356, and a processing unit 358.

The transmitting unit 352, receiving unit 354, memory unit 356, and processing unit 358 may send data to and/or receive data from one another using the data bus 359.

The transmitting unit 352 is a device that includes hardware and any necessary software for transmitting signals including, for example, control signals or data signals via one or more wired and/or wireless connections to other network elements in communications network 100.

The receiving unit 354 is a device that includes hardware and any necessary software for receiving wireless signals including, for example, control signals or data signals via one or more wired and/or wireless connections to other network elements in the communications network 100.

The memory unit 356 may be any device capable of storing data including magnetic storage, flash storage, etc.

The processing unit 358 may be any device capable of processing data including, for example, a microprocessor configured to carry out specific operations based on input data, or capable of executing instructions included in computer readable code including, for example code stored in the memory unit 356.

According to at least one example embodiment, operations described herein as being performed by either a relay server or a DVR server may be performed by the network element 351 having the structure illustrated in FIG. 3A. For example, the memory unit 356 may store executable instructions corresponding to each of the operations described with reference to FIGS. 2-5 as being performed by a relay server or a DVR server. Further, the processing unit 358 may be configured perform each of the operations described with reference to FIGS. 2-5 as being performed by a relay server or a DVR server, for example, by executing executable instructions stored in the memory unit 356.

An example method of operating the DVR server 210, first relay server 220 and network element 351 will now be discussed in greater detail below with reference to FIGS. 3B-5.

FIG. 3B is a flow chart illustrating a method for providing streaming video to multiple clients efficiently over a WAN link. FIG. 3B will be explained with reference to the wireless communications network 100 illustrated in FIG. 2.

Referring to FIG. 3B, in step S310, the DVR server 210 receives a media request from a first client. The media request may be received, for example, from the client 250A. The media request may include, for example, RTSP requests. For example, in accordance with known methods, the DVR server 210 may receive, from the client 250A, a RTSP DESCRIBE request specifying the URL of a media item, for example video data. The DVR server 210 may respond to the RTSP DESCRIBE request with a presentation description listing media streams associated with the specified URL. Further, in accordance with known methods, the DVR server 210 may receive, from the client 250A, a RTSP SETUP request asking the DVR server to setup a particular media item for streaming, and a RTSP PLAY request asking the DVR server 210 to stream the requested media item.

In step S320, the DVR server 210 determines if a total number of clients in the sub-network (subnet) of the first client that are receiving the media item requested by the first client exceeds a threshold value. For example, the DVR server 210 is aware of the subnets to which it is streaming video data. Upon receiving the media request from the client 250A, The DVR server 210 determines how many other clients on the client 250A's subnet, the second LAN 110B, are receiving or requesting the media item requested by the client 250A. If the determined number of clients including the client 250A does not exceed a threshold value, for example 2 users, the DVR server 210 proceeds to step S330.

In step S330, the DVR server 210 provides the requested media item to the first client. For example, in accordance with known methods, the DVR server 210 may provide requested media item to the first WAN link device 225 in the form of a video stream. The WAN link device 225 then sends the video stream to the client 250A via the WAN link 240 and the second WAN link device 224.

Returning to step S320, if the determined number of clients including the client 250A does exceed a threshold value, for example 2 users, the DVR server 210 proceeds to step S340.

In step S340, the DVR server 210 determines whether or not there are any relay servers which are currently receiving the media item requested by the first client and are closer to the subnet of the first client than the DVR server 210. For example, the DVR server 210 may be configured to determine the network topology of the communications network 100. Accordingly, the DVR server 210 can determine network distances between the DVR server 210 and the different subnets within the communications network 100 to which the DVR server 210 sends video data. Further, the DVR server 210 is capable of determining network distances between the subnets themselves. The term network distance as used herein may refer to, for example, data latency. Links which exhibit greater data latency may be considered to be longer in terms of network distance than links with lower data latencies. Though the physical distance between two points in a network may affect data latency for data sent over a link between the two points, physical distance is not the only factor which determines data latency. Accordingly, it is possible to have first link which is physically shorter than a second link, yet still longer in terms of network distance due to issues including an amount of traffic, noise or available bandwidth on each link, each of which may negatively affect data latency on the first link by increasing the data latency. Unless otherwise stated, as described herein, comparisons of distances between network elements and/or network entities (e.g. subnets, servers, etc.), including, for example, ‘closer’ or ‘farther’, refer to network distances.

If the DVR server 210 determines that there is a relay server in the communications network 100 which is receiving the media item requested by the client 250A, and is closer to the subnet of the client 250A, in terms of network distance, than the DVR server 210, the DVR server proceeds to step S350.

In step S350, the DVR server 210 initiates a relay server in the subnet of the first client and instructs the initiated relay server to obtain the requested media item from a closer relay server. For example, in step S340, the DVR server 210 may determine that there are one or more relay servers which are closer to the subnet of client 250A in terms of network distance, the second LAN 120B, than the DVR server 210 in terms of network distance. Accordingly, the DVR server 210 may initiate a relay server on the LAN second 120B, and may instruct the newly initiated relay server to obtain the requested media item from a relay server that is closer, in terms of network distance, to the second LAN 120B than the DVR server 110, and to offer the requested media item. After step S350, the DVR server 220 may proceed to step S370 which will be discussed in greater detail below.

If multiple relay servers are identified in step S340, then in step S350, the DVR server 210 may instruct the newly initiated relay server to obtain the requested media item from the relay server which is closest in in terms of network distance to the first client 250A. Initiation of relay servers will now be discussed in greater detail below.

According to at least one example embodiment, relay servers in the communications network 100 may be deployed dynamically. Accordingly, the relay servers may be configured such that they operate only after being instructed to operate by the DVR server 220. For example, while no relay server is operating on a particular subnet, the DVR server 210 may handle requests for video data from clients on that subnet by providing the video data to the client requesting the video data directly, without the use of a relay server. Further, the DVR server 210 may initiate a relay server on that subnet when the DVR server 210 determines that the number of clients on that subnet who are requesting that same video data exceeds a threshold value. This way, relay servers may be initiated dynamically, and thus, the relay servers only need to operate when their operation would be advantageous in reducing the bandwidth requirements for transmitting the video data over the WAN link or links connecting the DVR server 220 to the subnet. The DVR server 210 may initiate a relay server using control signals instructing the relay server to offer a particular media item.

Though the DVR server 220 is described above with reference to step S320 as determining when to initiate a relay server based on a total number of clients in a subnet and a threshold value, according to at least one example embodiment, the DVR server 220 may also determine when to initiate a relay server dynamically based on previous knowledge of the configuration of communication network 100. According to at least one example embodiment, the DVR server 220 may read current configuration and bandwidth usage information from routers and managed switches. Additionally, or alternatively, the DVR server 220 may probe the communications network 100 via methods including measuring the time to send data from the DVR server to a point near the clients. Accordingly, the DVR server 220 may choose whether or not to initiate a relay server by, for example, comparing any one or more of the read configuration information, bandwidth usage information, and probing results with threshold values.

Alternatively, according to at least one example embodiment, relay servers may be provided statically. Static relay servers may be configured to operate whenever video data is being received from the DVR 210 at the subnet of the relay server, and may provide copies of the received video data to clients on the same subnet, or other relay servers, regardless of the number of clients on the subnet that are requesting the same media item from the DVR server 220. For example, when relay servers are provided dynamically, instead of performing steps S320 and S330, the method illustrated in FIG. 3 may proceed directly from step S310 to step S340.

Returning to step S340, if the DVR server 210 determines that there are no relay servers in the communications network 100 which are receiving the media item requested by the client 250A, and are closer to the subnet of the client 250A, in terms of network distance, than the DVR server 210, the DVR server proceeds to step S360.

In step S360, the DVR server 210 initiates a relay server on the subnet of the first client. For example, in the same manner discussed above with reference to step S350, the DVR 210 may initiate a relay server on the subnet of the client 250A, the second LAN 120B. For example, the DVR sever 210 may send control signals to the first relay server 220 instructing the first relay server 220 to receive the requested media item and offer the requested media item. After step S360, the DVR 210 may proceed to step S370.

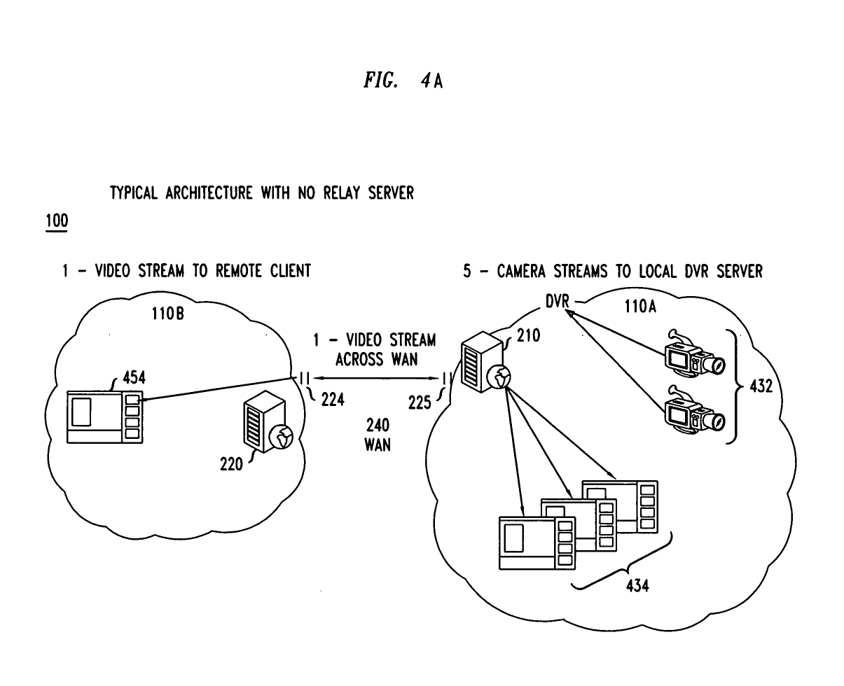

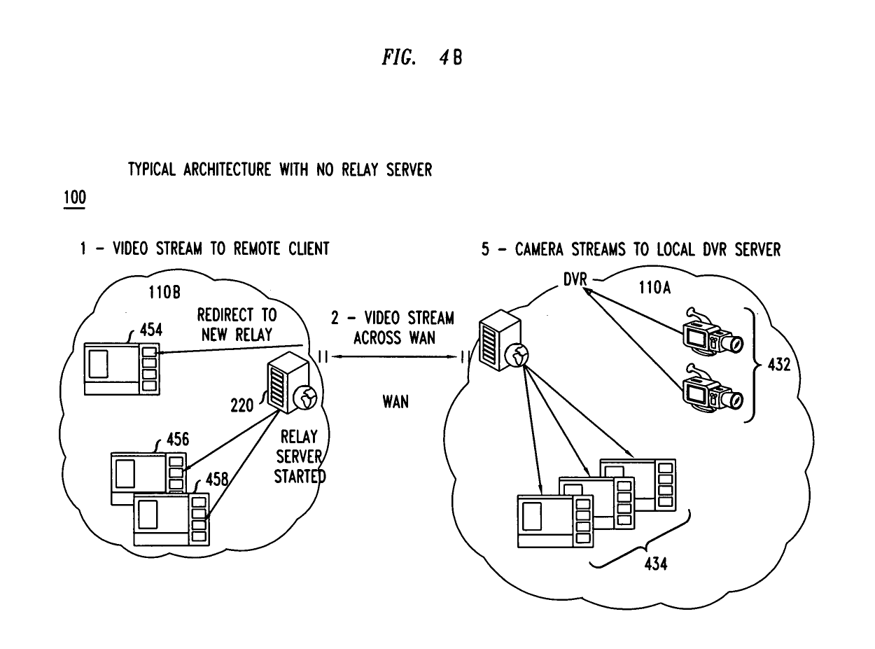

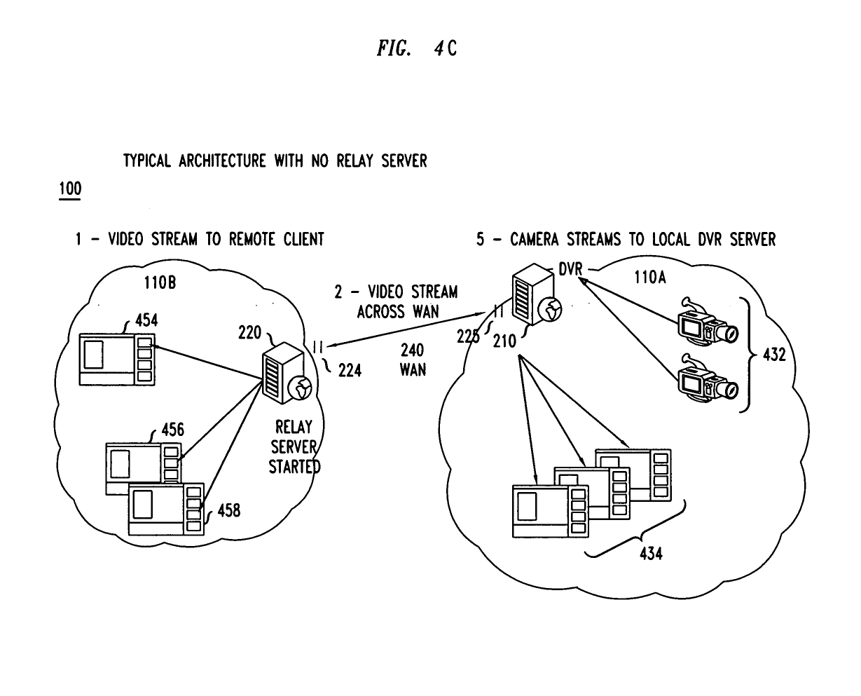

In step S370, the DVR 210 may instruct the first client to obtain the requested media item from the newly initiated relay server, and may redirect any other clients that are on the subnet of the first client and are currently receiving the requested media item from the DVR 210 to receive the requested media item from the newly initiated relay server. For example, in a case where the first relay server 220 is newly initiated on the second LAN 120B in response to a request, from the client 250A, for a media item, the DVR server 210 instructs the client 250A to obtain the requested media item from the first relay server 220. Additionally, if any of the other clients on the second LAN 120B are currently receiving the same media item requested by the client 250A from the DVR server 210, the DVR server may instruct those other clients to cease obtaining the media item from the DVR server 210, and start obtaining the requested media item from the first relay server 220. The DVR server 220 may send the client 250A, for example, a RTSP REDIRECT message including a URL of the first relay server 220 to instruct the client 250A to obtain the media item from the first relay server 220. The DVR server 220 may send the same RTSP REDIRECT message to the other clients on the second LAN 120B currently receiving the same media item requested by the client 250A from the DVR server 210. FIGS. 4A-4C illustrate an example operation of the communications network 100 where multiple remote clients are receiving requested video data. In FIGS. 4A-4C a number of clients in the second LAN 110B who are requesting video data from the DVR server 210 in the first LAN 110A increases from 1 to 3.

In the example illustrated in FIG. 4A, the DVR server 210 is receiving video data from video sources 432 and providing the video data, locally, to local clients 434. Further, a first remote client 454 in the second LAN 110B requests video data from the DVR server 210. As is explained above with reference to step S320 in FIG. 3, in response to the request for video data, the DVR server 210 determines if a total number of clients in the subnet of the first remote client 454 that are requesting video data the DVR server 210 exceeds a threshold value. In the example illustrated in FIGS. 4A-4C, the threshold value is one. However, the threshold value may be set to any number in accordance with the preferences of an operator of the communications network 100. Because the threshold value is one and only one remote client is currently requesting video data from the DVR server 210, the DVR server 210 provides the requested video data directly to the first local client 454 via the WAN 240 and the second WAN link device 224.

In the example illustrated in FIG. 4B, second and third remote clients, 256 and 258, on the second LAN 110B request the same video data being sent to the first remote client 454. As is described above with reference to step S320 in FIG. 3, the DVR server 210 determines that the total number of clients in the second LAN 110B that are requesting the video data being provided by the DVR server 210 is three, which exceeds the threshold of one. Consequently, the DVR server 210 determines that there are no initiated relay servers closer, in terms of network distance, to the second and third clients 454 and 456 than the DVR server 210, initiates the first relay server 220, sends the requested video data to the first relay server 220 and instructs the second and third clients 454 and 245 to obtain the requested video data from the first relay server 220.

As is shown in FIG. 4C, in accordance with step S370 illustrated in FIG. 3 and described above, the DVR server 210 also instructs all clients in the second LAN 110B that are currently receiving the requested video data directly from the DVR 110 (which includes only the first remote client 454 in the example illustrated in FIG. 4A) to obtain the requested video data from the newly initiated relay server 220.

FIG. 5 illustrates an example operation of the communications network 200 where multiple subnets are receiving requested video data. Communications network 200 is an expanded version of the communications network 100. Communication network 200 includes the first and second LANs 110A and 110B as well as third and fourth LANs 510A and 510B. In the same manner described above with reference to FIGS. 4A-4C, in the first LAN 110A, the DVR server 210 receives video data from the video sources 432 and provides the video data to local clients 434. Further, in response to requests for the video data from first remote clients 454 in the second LAN 110B, the DVR server 210 initiates the first relay server 220, and provides the requested video data to the first relay device 220 via the first WAN device 225, the first WAN link 240 and the second WAN link device 224. The first relay device 220 then provides the requested video data to the first remote clients 454.

Additionally, in the example illustrated in FIG. 5, after initiating the first relay server 220, requests for the video data being provided by the DVR server 210 are received from third remote clients 550A in the third LAN 510A and fourth remote clients 550B in the fourth LAN 510B. In the example illustrated in FIG. 5, the first relay server 220 is closer than the DVR server 210 with respect to both the third remote clients 550A of the third LAN 510A and the fourth remote clients 550B of the fourth LAN 510B. Thus, in accordance with steps S340 and S350 illustrated in FIG. 3 and described above, the DVR server initiates a third relay server 530 in the third LAN 510A, and instructs the third relay server 530 to obtain the requested video data from the first relay server 220.

Example embodiments being thus described, it will be obvious that embodiments may be varied in many ways. Such variations are not to be regarded as a departure from example embodiments, and all such modifications are intended to be included within the scope of example embodiments.

What is claimed:

1. A method of streaming media on an IP network, the method comprising:
receiving, at a media server, a request for a first media item from a first remote client in a first remote subnet of the IP network;
determining a total number of clients of the first remote subnet that are requesting the first media item from the media server;
generating a comparison result based on the determined number and a threshold value; and
if the generated comparison result indicates that the determined number is greater than the threshold value,
sending a signal from the media server to initiate a first relay server in the first subnet, and
sending a signal from the media server instructing the first remote client to obtain the first media item from the first relay server.

2. The method of claim 1, further comprising:
if the generated comparison result indicates that the determined number is greater than the threshold value,
determining if any other clients in the first subnet are receiving the first media item from the media server, and
instructing the other clients in the first subnet determined to be receiving the first media item from the media server to obtain the media item from the first relay server.

3. The method of claim 1, further comprising:
if the generated comparison result indicates that the determined number is greater than the threshold value,
determining if an intervening relay server exists, the intervening relay server being a relay server that is closer to the first client than the media server is;
if the intervening relay server is determined to exist,
streaming the first media item from the media server to the intervening server, and
sending a signal from the media server instructing the first relay server to obtain the first media item from the intervening relay server; and
if no intervening relay server is determined to exist, streaming the first media item from the media server to the first relay server.

4. The method of claim 1, further comprising:
if the generated comparison result indicates that the determined number is not greater than the threshold value, streaming the first item from the media server to the first client.

5. The method of claim 1, wherein the media server and the first remote client are in different subnets, and the media server communicates with the first subnet via a wide access network (WAN) link.

6. The method of claim 1, wherein the first media item includes video data.

7. A media server for facilitating the streaming of media on an IP network, the media server comprising:
a processing unit configured to control operations associated with streaming media, the operations including,
receiving, at the media server, a request for a first media item from a first remote client in a first remote subnet of the IP network;
determining a total number of clients of the first remote subnet that are requesting the first media item from the media server;
generating a comparison result based on the determined number and a threshold value; and
if the generated comparison result indicates that the determined number is greater than the threshold value,
sending a signal from the media server to initiate a first relay server in the first subnet, and
sending a signal from the media server instructing the first remote client to obtain the first media item from the first relay server.

8. The media server of claim 7, wherein the operations further include,
if the generated comparison result indicates that the determined number is greater than the threshold value,
determining if any other clients in the first subnet are receiving the first media item from the media server, and
instructing the other clients in the first subnet determined to be receiving the first media item from the media server to obtain the media item from the first relay server.

9. The media server of claim 7, wherein the operations further include,
if the generated comparison result indicates that the determined number is greater than the threshold value,
determining if an intervening relay server exists, the intervening relay server being a relay server that is closer to the first client than the media server is;
if the intervening relay server is determined to exist, streaming the first media item from the media server to the intervening server, and sending a signal from the media server instructing the first relay server to obtain the first media item from the intervening relay server; and
if no intervening relay server is determined to exist, streaming the first media item from the media server to the first relay server.

10. The media server of claim 7, wherein the operations further include,
if the generated comparison result indicates that the determined number is not greater than the threshold value, streaming the first item from the media server to the first client.

11. The media server of claim 7, wherein the media server and the first remote client are in different subnets, and the media server is configured to communicate with the first subnet via a wide access network (WAN) link.

12. The media server of claim 7, wherein the first media item includes video data.
